(19) United States
(12) Patent Application Publication
(10) Pub. No.: US 2014/0278062 A1
(43) Pub. Date: Sep. 18, 2014

(54) NAVIGATION SYSTEM FOR USE IN AN AIRPORT OR HARBOR TRANSPORTATION

(71) Applicants: Jae Hyun Han, Seoul (KR); Seung Ho Lee, Seoul (KR); You Chul Hwang, Goyang-si (KR)

(72) Inventors: Jae Hyun Han, Seoul (KR); Seung Ho Lee, Seoul (KR); You Chul Hwang, Goyang-si (KR)

(73) Assignee: THE KOREA TRANSPORT INSTITUTE, Goyang-si, Gyeonggi-do (KR)

(21) Appl. No.: 14/352,687

(22) PCT Filed: Apr. 20, 2012
(86) PCT No.: PCT/KR2012/003038

§ 371 Date: Apr. 18, 2014

(30) Foreign Application Priority Data
Oct. 18, 2011 (KR) 10-2011-0106209
Apr. 17, 2012 (KR) 10-2012-0039607

(51) Int. Cl. G08G 5/04; G08G 3/02

(52) U.S. Cl. CPC G08G 5/045; G08G 3/02
USPC 701/423

(57) ABSTRACT

The present invention relates to a navigation system for preventing an airplane or a ship carrying freight and passengers from becoming involved in an accident with other transport means. To this end, the navigation system of the present invention includes: a GPS module for obtaining position information on first transport means; an information searching module for searching second transport means positioned a predetermined distance away from the first transport means with reference to the position information and operation schedule of the first transport means; a path creating module for creating a secure path for the first transport means with reference to information on an operation path according to the operation schedules and the position information on the first and second transport means; and a display module for displaying the position information on the first and second transport means.

### TECHNICAL FIELD

The present invention relates to a navigation system for airport or harbor transportation and, more particularly, to a navigation system that is capable of preventing a collision accident between transportation means, such as airplanes or vessels that move in an airport and a harbor, or between such transportation means and service vehicles that move on an airport runway by referring to information about the movement of the transportation means.

### BACKGROUND ART

A transportation means, such as an airplane and a sea vessel for carrying a large amount of freight or a large number of passengers, though having low accident frequencies, may cause a great loss of life, a fatal life accident and serious property damage when an accident occurs. Trucks for transporting passenger freight, buses for transporting passengers, snowplow vehicles and various types of vehicles continuously move across an airport and runways, and thus there is a danger of a collision when airplanes take off and land from the runways. Furthermore, a sea vessel navigates along a predetermined line, but a collision accident between vessels may occur near a harbor or at sea because a predetermined transit path, such as a road on the ground, is not present

In the case of a vehicle that travels on a road, a driver who drives the vehicle may easily avoid adjacent vehicles by referring to surrounding traffic conditions because his or her response speed is fast In the case of a sea vessel, however, in bad weather conditions, such as foggy weather or a rough seas environment, it is difficult to detect the approach of an adjacent vessel in advance or to avoid a collision situation. In the case of an airplane, there is always the danger of a collision between the airplane and a vehicle that operates on or near an airport runway.

The size and weight of a sea vessel or airplane increases in proportion to increases in the amount of transported freight and in the number of passengers. This makes it difficult for the sea vessel or the airplane to immediately avoid the danger, although the danger is detected. As a result, although an accident frequency is low, a large-sized vessel or airplane frequently results in a large accident in proportion to its size and weight when an accident is generated.

Nevertheless, it is not easy for a central system to control such a collision situation. In particular, when the extensive infrastructure of an airport or a harbor is considered, there is a problem in that it is very difficult to construct overall related facilities or enormous expenses are required.

### DISCLOSURE

### Technical Problem

Accordingly, the present invention has been made keeping in mind the above problems occurring in the prior art, and an object of the present invention is to provide a navigation system that is capable of preventing an accident by referring to the locations of other airplanes and sea vessels located near transportation means, such as airplanes and vessels, and other transportation means, and reducing accidents attributable to large-sized transportation means by presenting an avoidance path related to a surrounding transportation means.

In particular, there is a good possibility that such an accident may occur when weather is bad. A navigation system, such as that of the present invention, is indispensable for situations in which there is heavy rain, snowfall, or thick fog. The navigation system according to the present invention is characterized in that it displays all transportation means whose movements are monitored, such as airplanes, sea vessels and other transportation means within a specific radius, in a single navigator, and maximally prevents a collision accident between the transportation means.

### Technical Solution

In accordance with the present invention, the above objects are achieved by a navigation system for airport or harbor transportation, including a GPS module obtaining information about a location of first transportation means; an information search module searching for second transportation means located a predetermined distance from the first transportation means by referring to the information about the location of the first transportation means and an operation schedule of the first transportation means; a path generation module generating a safe path of the first transportation means by referring to information about the locations of the first transportation means and the second transportation means and information about an operation path based on the operation schedule; and a display module displaying the information about the locations of the first transportation means and the second transportation means.

The navigation system may further include an operation schedule update module obtaining the operation schedule from a control server that controls an operation of the second transportation means and updating the obtained operation schedule.

The information search module may obtain information about a real-time location of the second transportation means by requesting the information about the real-time location from the control server, and determines a distance from the first transportation means.

The transportation means may be any one of an airplane and a vessel.

The safe path may be established by separating the first transportation means and the second transportation means by a predetermined distance along the operation path of the first transportation means.

The display device may display any one of an image and a shape of the second transportation means by flickering the image and the shape so that the image or shape can be distinctive.

The navigation system may further include a visual or auditory alarm device operating along with the navigation system or separately from the navigation system.

The navigation system may further include a humidity sensor or a photo sensor provided along with the navigation system or separately from the navigation system; and control means connected to the sensor and the alarm device and configured to control an ON or OFF operation of the alarm device; wherein the control means allows the alarm device to enter an ON state when humidity higher than predetermined reference humidity or an amount of light smaller than a reference light amount is detected by the humidity sensor, and allows the alarm device to enter an OFF state when humidity lower than the predetermined reference humidity or an amount of light greater than the reference amount of light is detected by the humidity sensor or the photo sensor.

### Advantageous Effects

According to the present invention, effects are expected in that a collision accident between an airplane or a sea vessel that transports freight and passengers and another airplane or a sea vessel is prevented and a collision accident between an airplane and various transportation means, such as vehicles, other than airplanes, that move in the runways of an airport can be prevented.

Furthermore, a collision between transportation means can be avoided with the utmost care by mounting only the navigation system on each transportation means without installing large-scale equipment requiring enormous expenses in an airport or a harbor, and thus in that a system can be easily constructed and also a high collision prevention effect can be achieved.

### DESCRIPTION OF DRAWINGS

FIG. 1 illustrates a reference diagram of the routes of airplanes and airport vehicles in an airport;

FIG. 2 illustrates a reference diagram of an embodiment of an interface screen of a navigation system according to an embodiment of the present invention;

FIG. 3 illustrates a reference diagram of another embodiment of an interface screen of the navigation system according to an embodiment of the present invention;

FIG. 4 illustrates a conceptual block diagram of the navigation system according to an embodiment of the present invention; and

FIG. 5 illustrates a reference diagram of an example of a connection relationship between the navigation system and a control server.

### MODE FOR INVENTION

The term “transport” refers to described in the present invention denotes an airplane, a vessel, a vehicle or the like.

The term “control server” described in the present invention may refer to a server for managing the entry and exit of airplanes or a server for managing the entry and exit of vessels. Furthermore, the term “control server” may be a separate server for managing the operation schedules of airplanes or vessels. The term “control server” described in the present invention may be the server of a company that transports passengers or freight, or may be a separate server for managing operation schedules under the commission of a company. Accordingly, a server for managing the operation schedules of airplanes or vessels is referred to as the control server, and is not particularly limited to whether it is independent or separate.

A navigation system described in the present invention may include a navigator, or may be terminologically interchangeable with a navigator. The navigation system may include a processor, memory and a display device, and the display device may be a touch screen that enables touch input.

The present invention is characterized in that:

1) the location of a first transportation means is specified by a GPS module, a second transportation means located a predetermined distance from the first transportation means is found by referring to information about the specified location of the first transportation means and an operation schedule;

2) the second transportation means is displayed on a display mean; and

3) a safe path of the first transportation means is generated by referring to information about the locations of the first and second transportation means and information about an operation path based on the operation schedule.

That is, the present invention is neither a simple radar system nor a simple navigator configured such that geographical features and planimetric features are fixed because the geographical features and planimetric features are previously input and the navigator is indicative of only the state of movement of a user. It should be noted that the present invention is technology specified to an airport in an attempt to maximally prevent an accident in an airport by displaying the location of an adjacent vehicle or airplane in a single navigation system in order to prevent a collision between vehicles and between a vehicle and an airplane in an airport, allowing a vehicle in which the navigation system is mounted to move along a virtually computed safe path and preventing a collision on the provided safe path by additionally providing an alarm device.

The present invention is described in detail below with reference to the drawings.

FIG. 1 illustrates a reference diagram of the routes of airplanes and airport vehicles in an airport.

Referring to FIG. 1, an airplane that transports a large amount of freight or passengers may move toward a predetermined runway on the ground, may reach the runway, and may then take off in direction A. After an airplane has taken off and landed, passengers who have boarded the airplane or freight that has been loaded into the airplane are moved by a separate vehicle (hereinafter referred to as an airport vehicle). Such airport vehicles are used to, after an airplane has taken off or landed, perform various tasks (hereinafter referred to as aviation business), such as searching for a runway in preparation for the takeoff and landing of an airplane on an airport or runway, scaring away birds that obstruct the takeoff or landing of the airplane, supplying oil to the airplane, or transporting manpower for the maintenance of the airplane, in addition to transporting passengers and freight

Accordingly, airport vehicles may be located on runways and in areas near the runways in time spans in which airplanes do not use the runways. During the periods in which airplanes do not take off or land, the airport vehicles may move to the runways or the areas near the runways in order to perform aviation tasks. If the aviation task is terminated within a short time, an airport vehicle may move to a predetermined location so that an airplane can move. In contrast, if the time it takes to perform aviation tasks is long or an emergency situation occurs, an airport vehicle needs to move to a runway or an area around a runway in order not to obstruct the movement of an airplane. In such a case, the airport vehicle needs to move while considering the direction of movement of an adjacent airplane and the relationship with the location of another airport vehicle.

FIG. 2 illustrates a reference diagram of an embodiment of an interface screen of a navigation system according to an embodiment of the present invention.

Referring to FIG. 2, the direction of movement of an airplane 20 that lands on and moves along a runway 10 is directed toward the direction of movement of an airport vehicle 50.

A navigator needs to prevent a rear-end collision between the airport vehicle 50 and the airplane 20 from occurring by preventing the airport vehicle 50 from passing through area A. The navigator may display, on the screen thereof, a safe path along which the airport vehicle 50 is headed for a designation (e.g., area E), the airport vehicle 50 does not pass through area A and thus a rear-end collision between the airport vehicle 50 and another airplane 90 is prevented.

In FIG. 2, the safe path is a path that passes through areas B-C-D-E, and a rear-end collision between the airplanes 50 and 90 may be prevented by making the airport vehicle 50 move through areas B-C-D-E.

In this case, the airplane 20 that is moving may be displayed on the screen in a flickering manner, or may be highlighted, thereby improving distinctiveness. In FIG. 2, an edge image in a box form is added in the vicinity of the airplane 20. The edge image may be represented using color different from that of a map, or the edge of the edge image may flicker so that the driver of the airport vehicle 50 is easily alerted of the airplane 20 that approaches the airport vehicle 50. A method of improving distinctiveness is not limited to the method.

If the safe path along which the airport vehicle 50 uses to avoid the airplane 20 is not appropriate, the navigator may display, on the screen, the location to which the airport vehicle 50 can escape.

In FIG. 2, information about the type and proximity time of the airplane 20 that moves toward the airport vehicle 50 is displayed on the left top of the screen.

Furthermore, the distance between the airplane 20 and the airport vehicle 50 may be further displayed on the path of the airplane 20. The driver of the airport vehicle may use another path, other than the safe path designated by the navigator, by referring to the distance between the airplane 20 and the airport vehicle and the proximity time.

FIG. 3 illustrates a reference diagram of another embodiment of an interface screen of the navigator according to an embodiment of the present invention.

FIG. 3 illustrates the interface screen of a vessel that moves through the sea, and illustrates an example in which a vessel 72 that moves through the sea from a harbor 71 avoids adjacent vessels 73 and 74. From FIG. 3, it can be seen that, in the vicinity of the vessel 72, the adjacent vessels 73 and 74 move toward the harbor 71, the adjacent vessel 73 moves along a path 78 and the adjacent vessel 74 moves along a path 75. The adjacent vessels 73 and 74 are illustrated as being placed at a location 2 km to 4 km away from the vessel 72. FIG. 3 illustrates that the radius of the adjacent vessels 73 and 74 displayed on the screen of the navigator is 2 to 4 km and a safe path is generated based on the adjacent vessels 73 and 74 placed within the distance. However, the reference distance may be longer or shorter than the aforementioned distance. That is, the reference distance is not limited to the aforementioned distance.

The navigator may display a path 77 as a safe path on the screen instead of the path 76 of the vessel 72. When the vessel 72 moves along the path 77, the danger of a rear-end collision between the vessel 72 and the adjacent vessels 73 and 74 is reduced compared to a movement along the path 76, and the vessel 72 may more safely navigate.

FIG. 4 illustrates a conceptual block diagram of the navigation system according to an embodiment of the present invention.

Referring to FIG. 4, the navigator may include a GPS module 110, an information search module 120, a path generation module 130, an operation schedule update module 140, a display module 150, and a database 160.

The GPS module 110 performs wireless communication with GPS satellites, and obtains information about the location of the navigator, that is, information about the real-time location of the airport vehicle 50 or the vessel 72. In this case, since the navigator is mounted on the airport vehicle 50 or the vessel 72, GPS location information may be the same as information about the location of the airport vehicle 50 or the vessel 72.

The information search module 120 searches for other transportation means located within a predetermined reference distance from the airport vehicle 50 or the vessel 72 by referring to the information about the location of the airport vehicle 50 or the vessel 72 and the operation schedules of the adjacent transportation means.

The information search module 120 may convert the current location of the airplane 20 or the adjacent vessels 73 and 74 by referring to operation schedule information included in the database 160, and the information search module 120 of the airport vehicle 50 or the vessel 72 may search for the airplane 20 or the adjacent vessels 73 and 74 that are expected to enter the reference distance through the converted location.

Alternatively, the control server may search for information about the airplane 20 or the adjacent vessels 73 and 74 located in the vicinity of the airport vehicle 50 or the vessel 72, and the information search module 120 may search for the airplane 20 or the adjacent vessels 73 and 74 located within the reference distance from the airport vehicle 50 or the vessel 72 using real-time location information. In such a case, the database 160 may obtain information about the real-time location of the adjacent vessels 73 and 74 or the airplane 20 through the operation schedule update module 140, and the information search module 120 may use information about the location of the airplane 20 or the adjacent vessels 73 and 74, which is stored in the database 160.

In this case, the reference distance may have a range of several hundreds of meters to 1 kilometer in the case of the airport vehicle 50, and may have a range of several kilometers to several tens of kilometers in the case of the vessel 72.

The path generation module 130 generates a safe path that enables the airplane 20 or the adjacent vessels 73 and 74 found by the information search module 120 to be avoided.

The path generation module 130 generates the safe path operative to avoid a collision by referring to the distance between the airport vehicle 50 or the vessel 72 and the airplane 20 or the adjacent vessels 73 and 74 located in the vicinity of the airport vehicle 50 or the vessel 72 and the distance between the transportation means, and provides the generated safe path to the display module 150.

The display module 150 may display the safe path, generated by the path generation module 130, on an electronic map, and may display information about the locations of the airplane 20 or the adjacent vessels 73 and 74, found by the information search module 120, on the electronic map in real time along with the safe path. In this case, the display module 150 may additionally display the distance, speed and type of the airplane 20 or the adjacent vessels 73 and 74 adjacent to the airport vehicle 50 or the vessel 72. The airplane 20 or the adjacent vessels 73 and 74 may be represented in color different from that of the electronic map, may flicker, or may be highlighted in a square, a triangle, a circle or one of various shapes so that the airplane 20 or the adjacent vessels 73 and 74 may be distinctive, but the present invention is not limited thereto.

The operation schedule update module 140 is connected to the control server over a wireless network. The operation schedule update module 140 obtains information about the locations of the airplane 20 or the adjacent vessels 73 and 74 or information about the operation schedules of the airplane 20 or the adjacent vessels 73 and 74 through the control server, and updates location information stored in the database 160 and operation schedule information.

The operation schedule update module 140 is required in order for the information search module 120 to track information about the locations of other transportation means located in the vicinity of the airport vehicle 50 or the vessel 72 in real time, and may not be required when the information search module 120 uses only information about the operations of the airplane 20 or the adjacent vessels 73 and 74.

For example, the information search module 120 may compute the locations of the airplane 20 or the adjacent vessels 73 and 74 every unit time (e.g., 1 minute) using information about the departure time, arrival time, destination and distance of the airplane 20 or the adjacent vessels 73 and 74. In such a case, the information search module 120 may search for the computed information about the locations of the airplane 20 or the adjacent vessels 73 and 74 and search for the airplane 20 or the adjacent vessels 73 and 74 located within the reference distance. The path generation module 130 may generate a safe path using the computed information about the locations of the airplane 20 or the adjacent vessels 73 and 74 and provide the generated safe path to the display module 150 so that the generated safe path is displayed.

FIG. 5 illustrates a reference diagram of an example of a connection relationship between the navigation system and the control server.

Referring to FIG. 5, the navigator 100 is connected to a single control server 200, and it may obtain information about an operation path and information about operation schedules.

If the navigator 100 is used in an airport, the control server 200 may be a control tower server within the airport. The control server 200 may be connected to one or more company servers 210 and 220 over a network. In FIG. 5, if the navigator 100 is mounted on the airport vehicle 50, the company servers 210 and 220 may be servers for respective airlines. The company servers 210 and 220 may provide the control server 200 with information about operation schedules and information about operation paths. The control server 200 may collect information about operation schedules and information about operation paths provided by the company servers 210 and 220, and may provide the collected information to the navigator 100.

Likewise, if the navigator 100 is used in the vessel 72, the control server 200 corresponds to a server for managing the entry and exit of the vessel 72 to or from a harbor. The control server 200 may obtain information about the operation schedules and operation paths of the vessels of companies from the servers 210 and 220 of the respective companies, and may provide the obtained information to the navigator 100.

Alternatively, the navigator 100 may directly access the company servers 210 and 220 over a wireless network, and may obtain information about the operation schedules and operation paths of airplanes or vessels of each company, but the present invention is not limited thereto and may include all other pieces of information.

Meanwhile, although not shown, the navigation system according to the present invention further includes an alarm device. The alarm device may include a visual alarm device or an auditory alarm device. The alarm device is an alarm device capable of subsidiarily giving an alarm when the navigator neglects to detect the danger of contact with a transportation means, such as an airplane or vessel that move nearby.

Such an alarm device may be visually displayed on the navigator directly or may be an auditory alarm device added to the navigator. Alternatively, the alarm device may be a visual or auditory alarm device provided separately from the navigator.

Furthermore, although not shown, the navigation system according to the present invention may further include a humidity sensor or a photo sensor and control means connected to the alarm device and the sensor. When humidity higher than a reference value is measured by the humidity sensor, the navigation system may determine a rainfall situation, a snowfall situation or a foggy situation. If the amount of light having a reference value or lower is measured by the photo sensor, the navigation system may determine day and night based on the amount of light, and may set an alarm system in an on state through the control means. Accordingly, the alarm device may be in an off state in normal times when the alarm system is not required and may be switched to an on state in bad weather conditions or night conditions, thereby being capable of providing the flexible operation of the alarm device.

As described above, the present invention has been described based on the preferred embodiments, but the present invention should not be interpreted as being limited to such embodiments and it is evident that the scope of the present invention should be determined by the interpretation of the following claims.

<Description of the Reference Numerals in the Drawings>

| | |
|---|---|
| 110: GPS module | 120: information search module |
| 130: path generation module | 140: operation schedule update module |
| 150: display module | 160: database |

1. A navigation system for airport or harbor transportation, comprising:
a GPS module obtaining information about a location of first transportation means;
an information search module searching for second transportation means located a predetermined distance from the first transportation means by referring to the information about the location of the first transportation means and an operation schedule of the first transportation means;
a path generation module generating a safe path of the first transportation means by referring to information about the locations of the first transportation means and the second transportation means and information about an operation path based on the operation schedule; and
a display module displaying the information about the locations of the first transportation means and the second transportation means.

2. The navigation system of claim 1, further comprising an operation schedule update module obtaining the operation schedule from a control server that controls an operation of the second transportation means and updating the obtained operation schedule.

3. The navigation system of claim 2, wherein the information search module obtains information about a real-time location of the second transportation means by requesting the information about the real-time location from the control server, and determines a distance from the first transportation means.

4. The navigation system of claim 1, wherein the transportation means is any one of an airplane and a vessel.

5. The navigation system of claim 1, wherein the safe path is established by separating the first transportation means and the second transportation means by a predetermined distance along the operation path of the first transportation means.

6. The navigation system of claim 1, wherein the display device displays any one of an image and a shape of the second transportation means by flickering the image and the shape so that the image or shape can be distinctive.

7. The navigation system of claim 1, further comprising a visual or auditory alarm device operating along with the navigation system or separately from the navigation system.

8. The navigation system of claim 7, further comprising:
a humidity sensor or a photo sensor provided along with the navigation system or separately from the navigation system; and
control means connected to the sensor and the alarm device and configured to control an ON or OFF operation of the alarm device;
wherein the control means allows the alarm device to enter an ON state when humidity higher than predetermined reference humidity or an amount of light smaller than a reference light amount is detected by the humidity sensor, and allows the alarm device to enter an OFF state when humidity lower than the predetermined reference humidity or an amount of light greater than the reference amount of light is detected by the humidity sensor or the photo sensor.
